(19) United States
(12) Patent Application Publication
(10) Pub. No.: US 2009/0243243 A1
(43) Pub. Date: Oct. 1, 2009

(54) E.E.Z.Z.CAR care garage caddy

(76) Inventor: Brad A. Watson, Monahans, TX (US)

Correspondence Address: BRAD A. WATSON, 2901 SOUTH HELEN AVE., MONAHANS, TX, 79756, US

(21) Appl. No.: 12/079,219

(22) Filed: Mar. 26, 2008

(51) Int. Cl. B62B 3/00

(52) U.S. Cl. 280/47.35

(57) ABSTRACT

Embodiment of E.E.Z.Z.CAR CARE GARAGE CADDY is to provide user with a caddy cart that completely organizes all car care products, maintenance, and cleaning and disposal needs as well as provide emergency equipment and personal cleaning needs of user into one handy time saving and easily maintained car care caddy cart that is also moveable, attractive, and easy for all ages to use.

### CROSS REFERENCE TO RELATED APPLICATIONS

This application claims the benefit of provisional application Ser. No. 12/079,219 filed Jan. 28, 2008 by present inventor.

### FEDERALLY SPONSORED RESEARCH

Not Applicable

### SEQUENCE LISTING OR PROGRAM

Not Applicable

### BACKGROUND

1. Field of Invention

Storing car care products, maintenance equipment, vacuuming equipment, personal cleaning and disposal needs for complete car care maintenance in one moveable garage caddy cart.

2. Prior Art

Car care products and car maintenance equipment to present date consists of storing all different equipment and car care products in many different area's including outdoor closet's, shelves, and cabinets both inside and outside home or business locations. Applicants new E.E.Z.Z. CAR CARE GARAGE CADDY embodiment makes a handy, time saving and space saving as well as attractive and easy to maintain caddy cart that can be easily moved for cleaning of garage or driveway. This car caddy makes organization of all your automobile or truck needs in maintenance and cleaning requirements readily available for home and business car care requirements, providing for a safer automobiles and trucks for all family and personal needs. The total organization of this car caddy makes car care so easy that even the teenagers in families can maintain a safer vehicle. This car caddy comes with the following equipment installed in its bottom cabinet area: 1. Battery charger with timer and boost capabilities, with cables on auto-return spool to keep cables neat and organized. 2. air compressor with hose also on auto return spool. 3. water holding tank with fill spout and water pump, and water hose also auto-return spool equipped. 4. vacuum cleaner that is wet dry equipped with 6 amp or better motor.

This car care caddy also has 4 drawers, 6 storage bins, 2 window wash bins with window squeegee's. Caddy has hooks on left end to hold 1½ ton hydraulic jack with handle and on other side a hand cleaner dispenser with applicator. Car caddy has a built in lighted center island for car care product storage on shelf of peg board backing. This island has fire extinguisher, paper towel dispenser, and car work light holder with light switch.

this caddy has vented cabinet doors on one side for heat outlet around equipment area's and walls or partitions dividing bottom into three sections. Enclosed cabinets help reduce equipment noise and provide weather protection to equipment.

This car care caddy is attractive, moveable, and easily maintained.

### SUMMARY

This E.E.Z.Z.CAR CARE GARAGE CADDY designed by applicant provides for a much easier way to maintain all vehicle needs providing users with safer vehicles and ease in operations of equipment and cleaning and car product use and organization, while also saving valuable garage space for other things. This system totally organizes home car care.

### DRAWINGS

### Figures

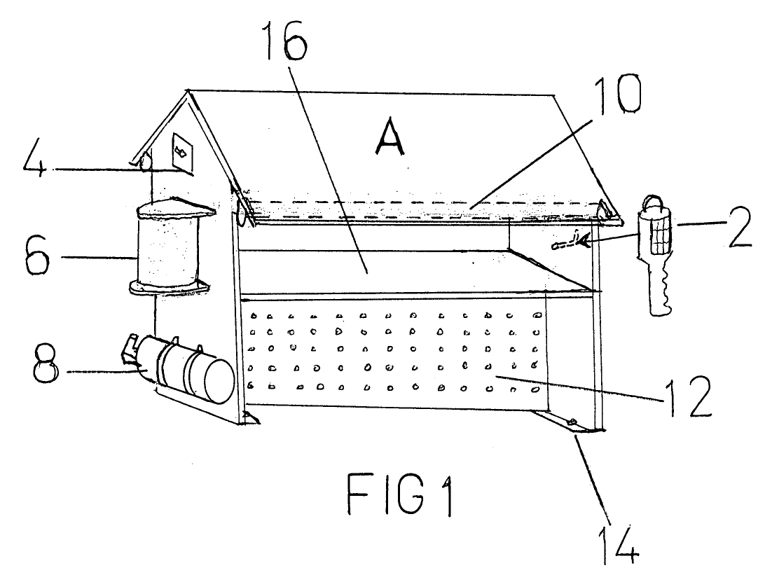

FIG. 1 Shows the top center isle of the car caddy or the lighted roof with storage shelves and pegboard.

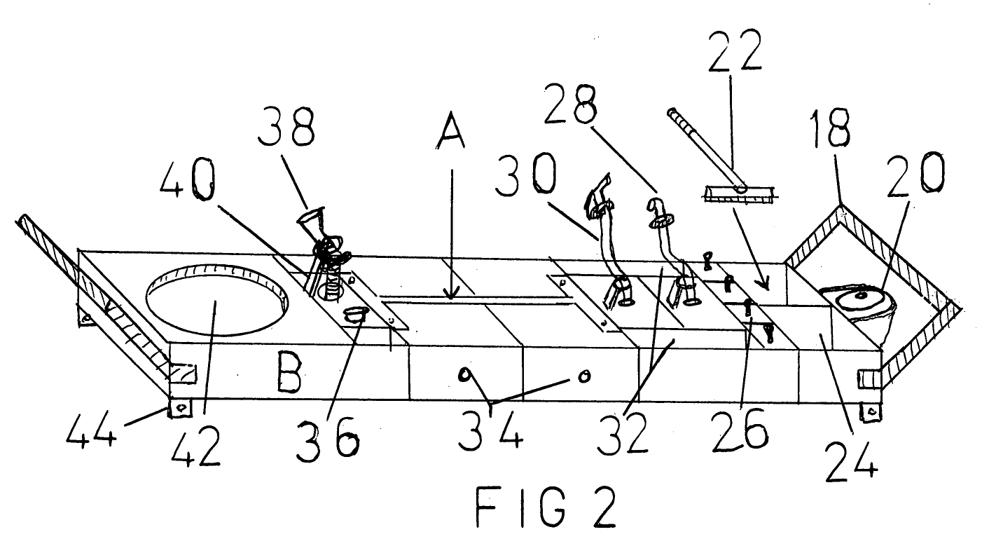

FIG. 2 Shows the top layer of the car caddy with its storage bins and window squeegee bins and hose holders.

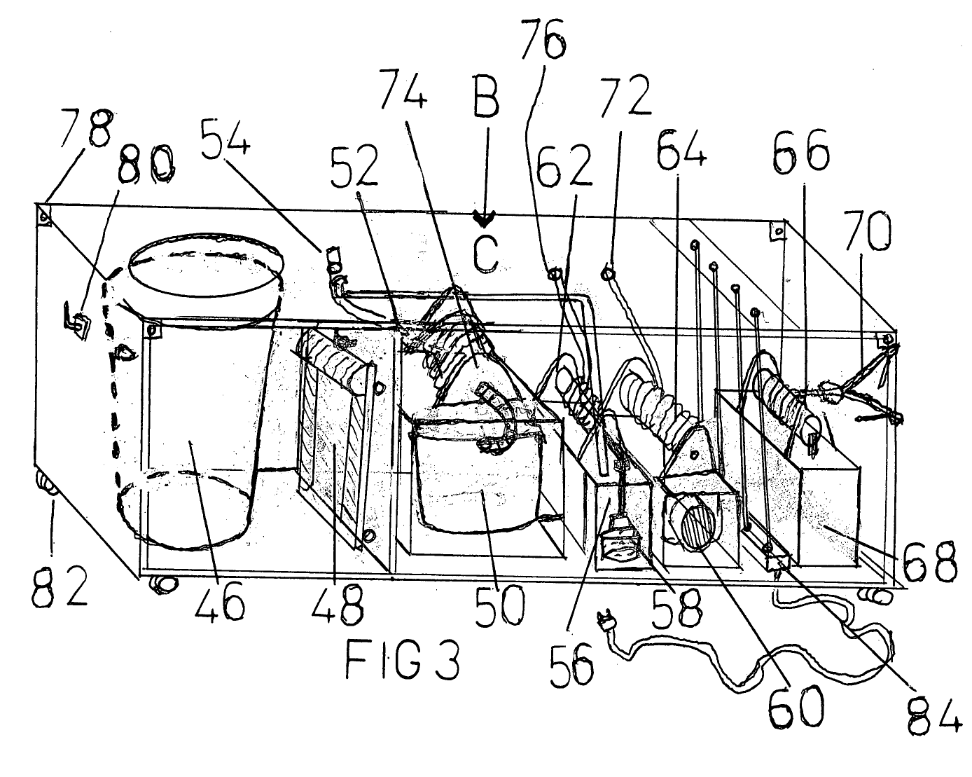

FIG. 3 Shows the bottom cabinet area of the car caddy with its different equipment compartments.

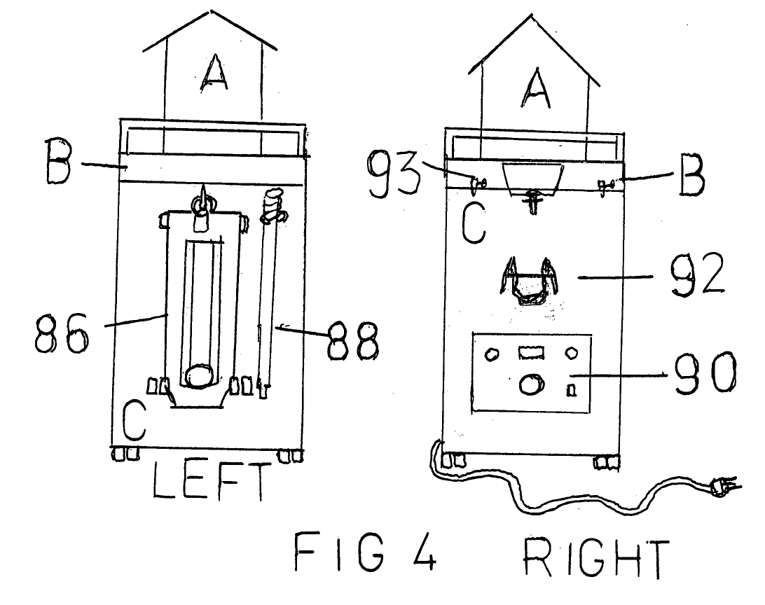

FIG. 4 Shows the left and right views of the ends of car caddy and equipment that is positioned on side by hooks or holders.

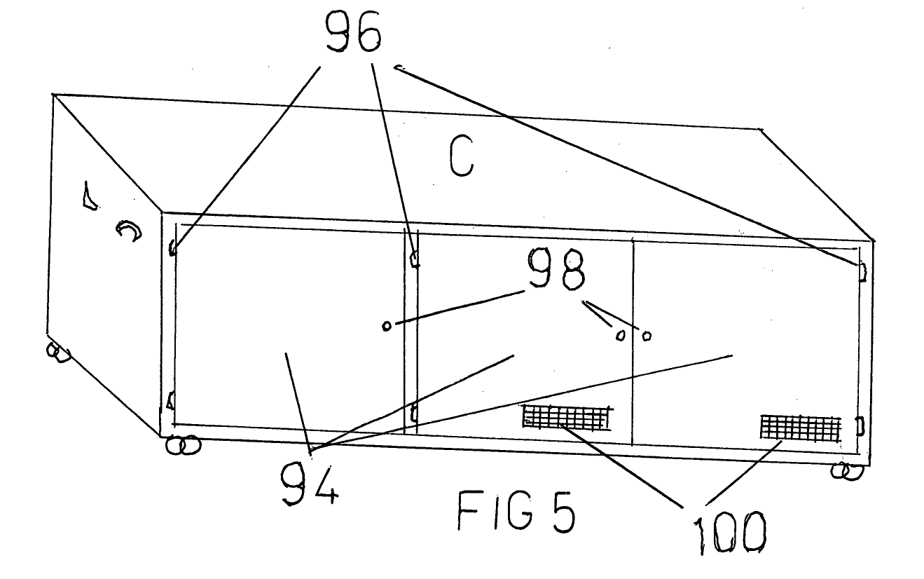

FIG. 5 Shoes and outside view of car caddy with its cabinet doors, door knobs and hinges, as well as vented doors.

### REFERENCE NUMERALS

2 Refers to the hand held battery operated car work light
4 Refers to the light switch for two florescent lights
6 refers to the paper towel holder and paper towels
8 Refers to the fire extinguisher and mounting strap
10 Refers to the two florescent lights one on each side of roof
12 Refers to the pegboard accessible from both sides of center island
14 Refers to the four bolt holes that allows center island to be attached to car caddy
16 Refers to the shelf of center island that is also accessible from both sides of caddy cart
18 Refers to the handles of car caddy which are located on both ends.
20 Refers to the hand cleaner dispenser located on right end.
22 Refers to the window washer squeegee's that are on right end of cart one for both sides
24 Refers to the window wash bins that hold water for squeegee's
26 Refers to the control panel for air, water, vacuum, and charger
28 Refers to the air compressor spigot with hose and spigot holder
30 Refers to the water spigot and hose and holder
32 Refers to storage bins located on both sides of caddy
34 Refers to the two drawers for storing tools on both sides of caddy
36 Refers to the water fill spout located on top of caddy
38 Refers to the vacuum head and hose and holder
40 Refers to the vacuum head holder
42 Refers to the trash cutout
44 Refers to four mounting bracketts to bolt top to cabinet
46 Refers to the 15 gallon trash can
48 Refers to the car work cart on wheels
50 Refers to the 6.5 Amp Wet vac
52 Refers to the dividing wall of cabinet
54 Refers to the wet vac hose outlet
56 Refers to the water holding tank 10 gallon capacity
58 Refers to the water pump for dispersing water through spigot
60 Refers to the 100 P.S.I. air compressor
62 Refers to the auto rewind hose reel for water hose
64 Refers to the auto rewind reel for air hose
66 Refers to auto rewind reel for battery cables
68 Refers to the Boost capable timer and adjustable charge battery charger
70 Refers to the battery cable heads passing through slot in cart
72 refers to air compressor hose outlet
74 Refers to the auto rewind reel for wet vac hose
76 Refers to water hose outlet
78 Refers to holes for top portion of cart to bolt on to lower cabinet of caddy
80 Refers to hook for 1½ tone hydraulic jack to mount on
82 Refers to dual steel swiveling wheel located on all four corners of car caddy
84 Refers to the electric plug station and control panel wiring hookups.
86 Refers to the 1½ ton hydraulic jack
88 Refers to hydraulic jack handle and holder
90 Refers to cutout in car caddy so control panel of battery charger is accessible
92 Refers to brace that holds battery charger clips or heads
93 Refers to the drain plugs located on both washer bins
94 Refers to the three cabinet doors
96 Refers to the hinges for each of the three doors
98 refers to the door knobs for the three cabinet doors
100 Refers to the vented cabinet doors on two portions.

### DETAILED DESCRIPTION

FIG. 1, 2 shows the battery powered hand held car work light which mounts on hook on side of center island console. 4 shows the light switch which operates two 24″ florescent lights one on each side of center island roof. 6 shows how paper towel dispenser is mounted on side of console. 8 shows how the fire extinguisher is mounted to console said extinguisher being type c. 10 shows the positioning of two florescent lights under roof area. 12 shows the pegboard that is in center of console accessible from both sides of car caddy. 14 shows the bolt holes on each of the corner portions of center island to bolt center island onto section B or top section of lower cabinet cart. 16 shows the shelf of center island that is also accessible from both sides of caddy.

FIG. 2, showing top portion of caddy cart with 18 showing the handles placed on both ends for easy move and 20 shows the hand cleaner dispenser located under handle. 22 shows the window squeegee's located in both end water bins 24. 26 Shows the control panel for the on/off switches for air, water, vacuum, and charger. 28 shows the air spigot head with rubber collar to rest on spigot holder. 30 shows the same with water spigot and it's holder. 32 Shows the two storage bins on each side of caddy to store parts or containers. 34 Shows the two drawers for each side of caddy cart for tools and wrenches, with knobs to open. 36 Shows the water fill spout for filling water holding tank. 38 shows the vacuum head of wet vac and it's holding bracket, 40 42 shows the trash can cutout in top portion of cabinet. 44 shows the mounting bracketts on each corner for holding sec B to Sec C.

FIG. 3, 46 shows the 15 Gallon capacity trash can located under cutout 42. 48 refers to the car work cart on wheels that fits on hook on wall 52. 50 refers to positioning of Wet-vac with hose attached to reel rewind 74. 52 Refers to the dividing wall in caddy cart. 54 shows how wet-vac hose is slotted to access hose use. 56 refers to the 10 gallon capacity water holding tank and 58 refers to pump to activate water dispense needs. 60 refers to the 100 P.S.I. air compressor with it's auto rewind reel for hose 64. 62 Refers to the auto rewind reel for water hose. 66 Refers to auto rewind reel for battery cables on battery charger 68 which has boost and timer capabilities. 70 refers to battery cable heads passing through wall of caddy for ease in use. 72 refers to hole cutout for air compressor hose and 76 refers to cutout for water hose use. 74 refers to auto rewind reel for wet-vac hose. 78 shows the bolt holes allowing sec B to mount to Sec C. 80 refers to the hook and clamp mount for hydraulic jack and handle 86 and 88. 82 Refers to the dual steel swiveling wheels located on all four corners of underside of caddy cart. 84 Refers to the electric plug in station and control panel hookup.

FIG. 4 showing left and right ends of cart with 86 showing 1½ Ton hydraulic jack and handle 88. 90 showing cutout in right side for access to battery charger controls, and cables with brace mount 92. 93 shows the drain spigots for the two window washer bins.

FIG. 5 showing outside of lower cabinet unit with three cabinet doors 94 and their knobs 98, and their hinges 96. 100 showing the vents on last two cabinet door for equipment ventilation.

### OPERATION

Applicants operation of said embodiment is quite simple. once you have purchased Caddy cart simply plug into electrical outlet, and fill holding tank with water, and install paper towel into holder. and position hydraulic jack on holder and fill hand cleaner dispenser, and car caddy cart is ready for use.

### ADVANTAGES

From the description described above it is evident that this car care garage caddy has many advantages to user and applicant will discuss some of these below.

(a) embodiment of complete car caddy cart enables user to have all car care products, cleaning agents, car maintenance needs, as well as user needs be embodied in the embodiment of caddy cart. Applicant has designed caddy cart so that if car is parked in garage front end first, all equipment needs are positioned in caddy cart where service can best be provided.

(b) caddy cart having four storage bins, four drawers, double sided shelf, and three cabinets makes plentiful storage and organization of users choice of car care products, engine additives, and maintenance requirements easy to organize and use.

(c) with auto rewind spools on all hoses or cables this helps keep caddy cart neat and hazard free.

(d) caddy cart having dual steel wheels on all four corners of caddy cart make moving or positioning of cart easy for cleaning garage or driveway.

(e) caddy cart prevents weather damage to electrical equipment as well as dampening noise levels when equipment is being used.

(f) caddy cart having fire extinguisher handy makes for a safer household or business premises.

(g) having all car care and maintenance equipment easily and handily available makes at home car care much more efficient and making for safer auto care a safer automobile for all families and business that use this car caddy cart. It's so easy to use and maintain that even teens can greatly improve on their car care needs making them also be safer by driving a safer vehicle that has been properly maintained.

(h) car care caddy cart is designed so that all equipment included in caddy cart can easily be removed for service if needed.

### CONCLUSION, RAMIFICATIONS, AND SCOPE

Accordingly, the scope of the embodiment should be determined not by the embodiments illustrated, but by the appended claims and their legal equivalents. design of applicants car care caddy cart is only applicants best suggested design of embodiment, there could be many variations in layout or positioning of equipment, as well as different heights, widths, and lengths. Car care caddy cart could also be stationary rather than mobile, lighted or unlighted and with or without all products applicant has included in his design. car care caddy cart could also be made of practically any type of solid material and be painted in any different color. The embodiment of applicants design is to provide a structure to include all car care maintenance equipment and car care cleaning and car fluids needs into one organized structure to make at home or business car care more handy and easy to perform for adults and teens to have safer automobiles. Organization of three or more maintenance products into mobile or stationary structure made of any material or for the purpose of providing organization of car care products, equipment or accessories should infringe on applicants embodiment. Applicants embodiment is to provide a structure where the most encompassing structure is to provide a place to store and organize all car care products but to also house all maintenance equipment, cleaning equipment, necessary fluids, as well as emergency and personal hygiene needs of user, and automobile.

Applicants overall measurements of car caddy cart are 20″ wide, 7′ long, and 38″ tall to top of cabinet portion of lower unit. Center island applicant recommends 14″ wide by 24″ long, by 30″ high. These are only applicants suggested dimensions and as stated above car caddy system could be designed in almost any logical dimensions and could be arranged or organized in many different ways. Applicants recommendation for material to be made of is aluminum, or steel, and or stainless steel, for durability and rust resistant purposes.

I claim:

1. Embodiment of caddy cart made of aluminum or stainless steel and to have lower cabinets for car maintenance equipment to be placed either permanent or removeable and to also contain trash can and automatic return spools and car work cart. Four drawers, four storage bins, and two window wash bins with drain spouts. Said embodiment also to have center island storage area which includes shelf, pegboard backing, and lights with paper towel dispenser and light switch. Caddy cart mounted on four dual steel wheels.

2. Said embodiment to also come with the following maintenance equipment and emergency and cleaning dispensers. (a) battery charger with boost and timer capabilities (b) air compressor with 100 psi capabilities (c) water holding tank with pump and hose and spigot (d) wet vacuum and hose with vacuum head (e) car work cart (f) trash can (g) fire extinguisher (h) water fill spout (i) holding bracketts for all hoses and cables (j) switch panel for all electrical equipment (k) battery powered car work light (l) two window washer squeegees (m) 1½ ton hydraulic jack (n) hand cleaner dispenser (o) handles on both ends of caddy cart (p) electric outlet for all appliances (q) electric wire 10′ long with male end.

3. A rectangular shaped cart with wheels on each corner and handles on each end near top of cart body said cart main body to contain a 32″ tall by 24″ wide lower cabinet area divided into three equal compartments with opening and closing cabinet doors on one side, two also being vented, with all having latches to hold door shut The cart also having an upper petition containing storage bins, equipment control panel, holding arms for all cables, hoses with their individual head attachments, and also four drawers for storage and water fill spout and two bins with drain spigots for window washer squeegees. The cart to also have a center island console which extends upward in middle of said cart with florescent lights, paper towel dispenser, fire extinguisher and mounting bracket, with light switch and holder for car work light. Said center console to also have a two sided shelf and pegboard backing for additional parts storage.

4. The invention of claim 3 further containing a battery charger with boost capabilities and also having a auto rewind spool for cables, said battery charger mounted to bottom of cart by bolts and nuts.

5. The invention of claim 3 also having a air compressor capable of producing up to 100 PSI also having an auto rewind spool for its air hose attachment.

6. The invention of claim 3 also having a holding tank for water, with pump and hose also attached to auto rewind spool.

7. The invention of claim 3 also having a wet vacuum with hose also attached to auto rewind spool.

8. The invention of claim 3 further having a trash can in lower cabinet area with handles for easy service.

9. The invention of claim 3 further comprising of a hand cleaner dispenser mounted under handle on one end of said cart.

10. The invention of claim 3 also having hooks to hold 1½ ton hydraulic jack and handle also under handle of opposite side of said cart

11. The invention of claim 3 further comprising of a car work cart on rotatably turning wheels with hanger on inside wall portion of lower cabinet area of said cart.

12. The invention of claim 3 also having two window washer squeegees that are placed inside washer bins on each side of one end of said cart.

13. The invention of claim 3 also having a class C fire extinguisher with mounting bracket on lower side of center island console.

14. The invention of claim 3 containing a water fill spout with screw on cap located on top storage area of cart with hose connected to water holding tank for fill operation.

15. The invention of claim 3 to also have two florescent lights in roof area of center island console with light switch.

16. The invention of claim 3 to also have all electrical components needed including switches installed within body of said cart, so that all electrical equipment can be operated from control panel or switches provided there in.

17. The invention of claim 3 shall also contain four dual steel rotatably turning wheels placed one on each corner of said cart.

18. The invention of claim 3 shall also contain a car work light that is battery operated with it's hanger on side of center island console.

19. The invention of claim 3, shall also contain all holding arms for equipment described and head attachments for all the different equipment operating needs.

20. The invention of claim 3 shall consist of stainless steel siding for bins panels and drawer areas as well as outside body of cart.

22. The invention of claim 3 shall further contain pegboard and stainless steel shelves for center island console.

23. The invention of claim 3 is 24″ by 38″ high in main body of cart with a center console being 1′ wide by 2′ tall by 2′ long and overall cart length to be about 7′ long.
